(19) United States
(12) Patent Application Publication
(10) Pub. No.: US 2024/0062268 A1
(43) Pub. Date: Feb. 22, 2024

(54) WEAKLY-SUPERVISED COMPATIBLE PRODUCTS RECOMMENDATION

(71) Applicant: Home Depot Product Authority, LLC, Atlanta, GA (US)

(72) Inventors: Rongzhi Zhang, Atlanta, GA (US); Rebecca West, Smyrna, GA (US); Xiquan Cui, Brookhaven, GA (US)

(21) Appl. No.: 17/891,304

(22) Filed: Aug. 19, 2022

(51) Int. Cl. G06Q 30/06; G06N 3/04

(52) U.S. Cl. CPC G06Q 30/0631; G06N 3/04

(57) ABSTRACT

A computer implemented method for determining object compatibility includes obtaining a first data set, a second data set, and a first compatibility model. The method also includes determining, by the compatibility system, error instances in the second data set by applying the first compatibility model to the second data set. The method further includes determining, by the compatibility system, labeling rules based on the error instances, and determining a third data set by applying the labeling rules to the first data set. The method also includes determining, by the compatibility system, a second compatibility model based on the third data set and determining an ensemble compatibility model based on the first compatibility model and the second compatibility model. The method further includes determining, by the compatibility system, a product recommendation based on the ensemble compatibility model and a user selection of a first product.

### FIELD

The present disclosure generally relates to the field of product attribute identification techniques for determining compatible products, to improve product recommendations displayed to a user on an e-commerce platform, for example.

### BACKGROUND

Online e-commerce platforms (accessible through web sites, applications, and the like) typically offer product searching or browsing features, in which one or more products are displayed on a web page. Each product listing is shown with an image, name, price, and/or availability of the product. On some platforms, a product listing includes other product recommendations that may be bundled with the listed product based on a user's search history, a co-purchase history of the listed product, and/or a functional compatibility between products.

### SUMMARY

In some aspects, the techniques described herein relate to a computer implemented method for determining object compatibility using a compatibility system, the method including: obtaining a first data set, a second data set, and a first compatibility model; determining, by the compatibility system, error instances in the second data set by applying the first compatibility model to the second data set; determining, by the compatibility system, labeling rules based on the error instances; determining, by the compatibility system, a third data set by applying the labeling rules to the first data set; determining, by the compatibility system, a second compatibility model based on the third data set; determining, by the compatibility system, an ensemble compatibility model based on the first compatibility model and the second compatibility model; and determining, by the compatibility system, a product recommendation based on the ensemble compatibility model and a user selection of a first product.

In some aspects, the techniques described herein relate to a method, wherein determining the error instances further includes: determining, by the compatibility system, a first weight for each instance of the second data set; determining, by the compatibility system, an error rate based on the second data set; determining, by the compatibility system, a weight coefficient for the first compatibility model; and determining, by the compatibility system, a second weight for each instance of the second data set.

In some aspects, the techniques described herein relate to a method, further including: wherein the instances in the second data set with higher second weights are treated as large error instances, and wherein the labeling rules are based on the large error instances in the second data set.

In some aspects, the techniques described herein relate to a method, wherein the ensemble compatibility model further includes a weighted ensemble of preceding compatibility models, wherein each preceding compatibility model includes a weight coefficient.

In some aspects, the techniques described herein relate to a method, further including: wherein the first data set includes unlabeled product pair data, the unlabeled product pair data includes an anchor product from a product category and randomly sampled second products from the product category, wherein the anchor product includes the first product selectable by the user.

In some aspects, the techniques described herein relate to a method, wherein the second data set includes labeled product pair data from a preceding iteration.

In some aspects, the techniques described herein relate to a method, wherein the third data set includes labeled product pair data based on the labeling rules being applied to the first data set.

In some aspects, the techniques described herein relate to a method, wherein applying the labeling rules to the first data set includes providing an indication of the compatibility for each product pair in the first data set.

In some aspects, the techniques described herein relate to a method, wherein the labeling rules include being based on shared attributes from first product attributes and second product attributes of the products in the product pair.

In some aspects, the techniques described herein relate to a method, further including: wherein the first product attributes include structured product attributes; and wherein the second product attribute include unstructured product attributes.

In some aspects, the techniques described herein relate to a computer-implemented method for determining object compatibility using a neural network, the method including: obtaining a first data set, a second data set, and a first compatibility model; determining, by the neural network, error instances in the second data set by applying the first compatibility model to the second data set; determining, by the neural network, labeling rules based on the error instances; determining, by the neural network, a third data set by applying the labeling rules to the first data set; determining, by the neural network, a second compatibility model based on the third data set; determining, by the neural network, an ensemble compatibility model based on the first compatibility model and the second compatibility model; and determining, by the neural network, a product recommendation based on the ensemble compatibility model and a user selection of a first product; wherein the labeling rules include being based on shared attributes from first product attributes and second product attributes of the products in a product pair.

In some aspects, the techniques described herein relate to a method, wherein determining the error instances further includes: determining, by the neural network, a first weight for each instance of the second data set; determining, by the neural network, an error rate based on the second data set; determining, by the neural network, a weight coefficient for the first compatibility model; and determining, by the neural network, a second weight for each instance of the second data set.

In some aspects, the techniques described herein relate to a method, further including: wherein the instances in the second data set with higher second weights are treated as large error instances, and wherein the labeling rules are based on the large error instances in the second data set.

In some aspects, the techniques described herein relate to a method, wherein the ensemble compatibility model further includes a weighted ensemble of preceding compatibility models, wherein each preceding compatibility model includes a weight coefficient.

In some aspects, the techniques described herein relate to a method, further including: wherein the first data set includes unlabeled product pair data, the unlabeled product pair data includes an anchor product from a product category and randomly sampled second products from the product category, wherein the anchor product includes the first product selectable by the user.

In some aspects, the techniques described herein relate to a method, wherein the second data set includes labeled product pair data from a preceding iteration.

In some aspects, the techniques described herein relate to a method, wherein the third data set includes labeled product pair data based on the labeling rules being applied to the first data set.

In some aspects, the techniques described herein relate to a method, wherein applying the labeling rules to the first data set includes providing an indication of the compatibility for each product pair in the first data set.

In some aspects, the techniques described herein relate to a method, further including: wherein the first product attributes include structured product attributes; and wherein the second product attribute include unstructured product attributes.

In some aspects, the techniques described herein relate to a system for determining product compatibility using an ensemble compatibility model, the system including: a processor; and a non-transitory, computer-readable memory storing instructions that, when executed by the processor, cause the system to perform a method including: obtaining a first data set, a second data set, and a first compatibility model; determining, by a neural network, error instances in the second data set by applying the first compatibility model to the second data set; determining, by the neural network, labeling rules based on the error instances; determining, by the neural network, a third data set by applying the labeling rules to the first data set; determining, by the neural network, a second compatibility model based on the third data set; determining, by the neural network, an ensemble compatibility model based on the first compatibility model and the second compatibility model; and determining, by the neural network, a product recommendation based on the ensemble compatibility model and a user selection of a first product; wherein the labeling rules include being based on shared attributes from first product attributes and second product attributes of the products in a product pair.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a block diagram of an example compatibility system, according to some embodiments,

FIG. 2 is a block diagram of an example neural network, according to some embodiments.

FIG. 3 is a block diagram of an example compatibility system, according to some embodiments.

FIG. 4 is a block diagram of an example compatibility system, according to some embodiments.

FIG. 5 is a flow chart of a method for determining recommended products, according to some embodiments.

FIG. 6 is a flow chart of the method for determining recommended products, according to some embodiments.

FIG. 7 is a diagrammatic view of an example user computing environment, according to some embodiments.

### DETAILED DESCRIPTION

Compatible products prediction techniques are typically used to provide recommended other products based on a user selection of a first product. For example, if a user selects a first product from a first product category (i.e., lighting fixture), the compatibility prediction model attempts to provide the user with recommended other products from other related product categories for the first product (i.e., lighting bulbs). A typical compatibility prediction model training process involves using manually created labeling rules sourced from knowledge bases, identified patterns, or from human input. These weakly labeled rules may be matched with unlabeled data to create larger weak label sets to train natural language processing (NLP) models. It is desirable to train and validate a product compatibility prediction model to provide recommended other products based on a user selection of a first product with a high degree of confidence and accuracy, particularly when the other product falls into a compatible product category but has scarce product data or merely has an unformatted product description.

Compatible product prediction may be challenging due to the lack of manually curated data to train the NPL model and the heterogeneity of product data. Clean labeling data is generally not readily available. Further, manually labeling product data for NPL models is time-consuming. Although user behavior data may be implemented to create pseudo labeling rules, the reliability of such data may be diminished because such data does not accurately reflect the compatibility of two respective products. Consequently, labeling rules typically focus on a narrow number of product attributes while ignoring other product attribute sources such as the buried compatibility data in product descriptions.

A known product recommendation technique involves using weakly supervised language (WSL) to provide automatically discovered rules using a manually created initial rule set. This technique, however, is often hindered by the low quality of the initial rules and the static learning process. It is challenging to provide a comprehensive and high-quality set of labeling rules a priori because manually creating rules involves a significant concentration of effort. Further, the discovered rules are restricted to frequent patterns and predefined types. Moreover, the performance of other typical WSL methods is largely determined by the quality of the initial weak sources. Therefore, incorrect data results in error propagation and model deterioration. Although some techniques have implemented certain rule discovery methods to solicit feedback to refine rule sets, such rule discovery methods are limited to simple repetitive structures (i.e., n-gram) and the large rule search space makes previous approaches not feasible for large datasets.

Alternatively, known product recommendation techniques involve pattern-based classification. Pattern pools are constructed based on pattern frequency, and then the most discriminative patterns are selected via heuristics. However, the large pattern pool renders such computation inefficient, and the number of selected patterns limits the interpretability. Prior product recommendation techniques overcome these features by implementing prefix paths in tree-based models and by implementing additional filtering for the effective tree-based models. Other product recommendation techniques filter unnecessary features from tree models. Although such methods improve interpretability and efficiency, they do not explore the weakly supervised settings and focus on discovering novel compatibility rules to perform compatibly products prediction.

Various embodiments of the present disclosure address these challenges by leveraging user behavior data to generate weakly labeled instances against random product pairs. For example, the co-purchase data for a particular product is used to generate positive labeling instances, whereas the randomly sampled product pairs form negative labeling instances. Without iteratively discovering labeling rules, a product recommendation engine based on a static rule set may generate product recommendations for products that are not compatible.

Various embodiments of the present disclosure address these challenges by iteratively weighing data sets by focusing on large error instances. Consequently, such a technique is limited from enumerating large rule sets, while novel rule sets are filtered prior to integration. However, the rules that are proposed for integration are complementary to the previous model iteration. Aspects of the present disclosure provide rule proposals by implementing rules based on structured and unstructured product data. The first rule is a decision-tree based rule generation where structured product attributes are selected to form a rule proposal. Further, the product descriptions are used to generate a second rule proposal as a fallback rule based on a pretrained language model (PLM) capturing hidden information in an unstructured body of text.

As described herein, the terms “compatibility model,” “weakly supervised language,” “neural network,” and “natural language processing” may generally refer to a computational model or processes implemented by the computational model to convert information from an input form (e.g., text data) to an output form (e.g., feature value, object instance, labeled object, etc.). The particular machine learning tools or models used may vary among implementations, depending on the particular task, the type of data being processed, and other factors. It will be appreciated that any description of a particular type of model is provided for explanatory purposes, and that suitable alternative tools or models may also be used.

As described herein, the term “object” may refer to a product included in any of a plurality of data sets representative of a product in the inventory and for sale by a retailer. The object can be a product in a product pair.

As described herein, the term “object instance” may refer to any metric representative of a compatibility between two products (i.e., product pair). The compatibility prediction may be a metric value and may be determined based on an application of an iterative rule set to the product pair to indicate a positive compatibility, a negative probability, and/or an indication that the product pair is unmatchable based on the available product data, the current rule sets, other factors, and combinations thereof.

As described herein, the term “structured product attribute,” and “structured attribute” may refer to high-cardinality data related to a particular product and/or the features of the particular product. Decision tree generation is applied to the structured product attributes of two or more products to determine the shared feature values of the two or more products. The permutation importance of each shared attribute may also be determined to indicate whether the feature be applied as the atomic unit of rules.

As described herein, the term “unstructured product attribute,” and “unstructured attribute” may refer to unlabeled data (e.g., product overviews, product descriptions, etc.). Predefined rule templates are constructed from sparse and/or missing data from the structured product attributes, and a rule prompt is formed from the rule template. The product description is then used to prompt the PLM to fill a [MASK] token to propose candidate rules. Such an approach is further distinguished from rules extracted from surface patterns (e.g., n-gram rules) as such prompt-based rule proposals may generate words that do not appear in the original inputs.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure are intended to be illustrative, and not restrictive.

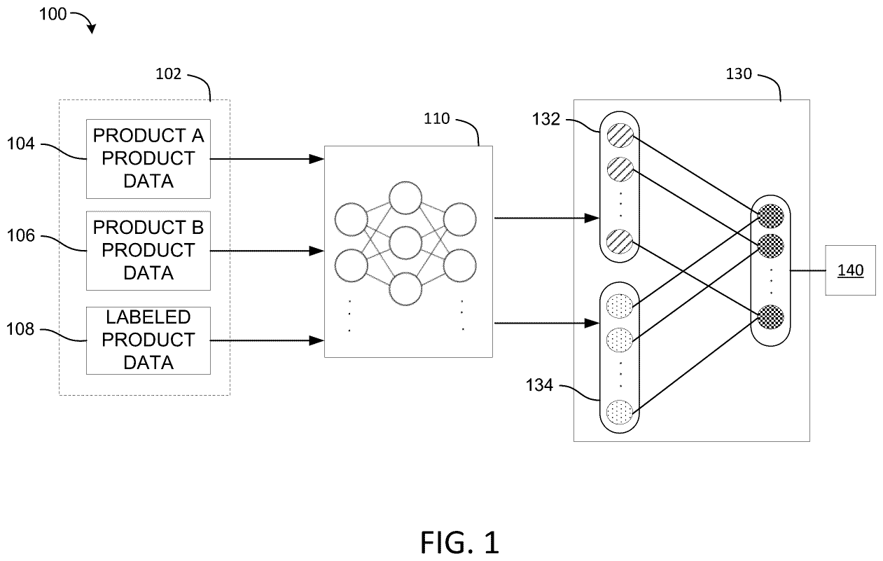

FIG. 1 is a block diagram of an example compatibility system 100 for determining a product compatibility between two respective products, according to some embodiments. The compatibility system 100 may include an input stage 102, a network stage 110, a comparison stage 130, and an output stage 140. The input stage 102 may include product data 104 of product A, product data 106 of product B, and labeled product data 108. The network stage 110 receives data from the input stage 102 and generates a pair of embeddings 132 and 134, with the embedding 132 including product attributes associated with the product data 104 of product A, and the embedding 134 including product attributes associated with the product data 106 of product B. In some embodiments, the embeddings 132 and 134 may each be a qualitative representation of one or more product attributes associated with the respective product. In some embodiments, the embeddings 132 and the embeddings 134 may each be a quantitative representation of one or more product attributes associated with the respective products. At the comparison stage 130, the embeddings 132 and 134 may be compared or otherwise evaluated to determine a compatibility label between embeddings 132 and 134. The operations performed at the comparison stage 130 may then serve as the basis for the output stage 140, to output a determination of whether product A and product B are compatible, and/or to serve as inputs into additional processes (e.g., placement of products into a labeled dataset, product compatibility ranking, product recommendation engine, placement of products into a catalog or taxonomy, etc.).

The Product A product data 104 and the Product B product data 106 may be labeled data from the labeled product data 108. In some embodiments, the Product A product data 104 and Product B product data 106 may include product corpus data. In some embodiments, the product corpus data may include structured product attributes and unstructured product attributes. The structured product attributes may include qualitative attributes and quantitative attributes in the representation of the particular product. In some embodiments, the structured product attributes may be populated using neural networks, pre-trained language models (PLM), natural language processing (NLP) models, machine learning engines, heuristics, manually entered data by an expert or administrator, other methods, and combinations thereof. For example, product A may be a ceiling lighting fixture and the structured product attributes may include information relating to the lighting fixture type, sub-type, connection type, features, color, compatible light bulb base codes, maximum bulb wattage, compatible bulb types, fixture finish, material, and other high cardinality attributes. In some embodiments, the product corpus data may include unstructured product attributes. The unstructured product attributes may include unlabeled product description data of the particular product (e.g., product description, product overview, other low cardinality text blocks, etc.). In some embodiments, the unstructured product attributes may be further processed using neural networks, PLM, NLP models, machine learning engines, heuristics, other methods, and combinations thereof, to extract additional product attributes from the unlabeled product description.

The labeled product data 108 may include a plurality of labeled product pairs. In some embodiments, each product pair in the labeled product data 108 includes an object instance indicating a compatibility of the product pair. In some embodiments, each product pair may have been assessed by an ensemble compatibility model of the compatibility system 100 to indicate the compatibility between the products in the product pair. The labeled product data 108 may include any representation of a category or categories to which the product data 104 of product A and/or the product data of product B belongs. In some embodiments, the product pairs may include an anchor product and any of a plurality of other products from the same category as the anchor product. In some embodiments, the labeled product data 108 may include data representing a plurality of information on each product in the product pair, including but not limited to data representing product type (e.g., lighting, appliance, bathroom, tools, etc.), product subcategory (e.g., lighting fixture, light bulbs, etc.), product corpus, structured product attributes, and unstructured product attributes, and other data. In some embodiments, the labeled product data 108 may include information on the structured product attributes and/or the unstructured product attributes of the products in a product category. In some embodiments, the labeled product data 108 may include a purchase history data for products A and/or product B. In some embodiments, the labeled product data 108 may include a co-purchase data for product A and product B. In some embodiments, the labeled product data 108 may include a weighting for each object instance associated with each product pair. The level of granularity between product category, subcategory, purchase history, co-purchase data, randomly sampled data, and product corpus may vary among implementations and may depend on factors such as the size of a retailer's catalog, the computing resources used to implement the compatibility system 100, the amount of initial data available with which to configure the compatibility system 100, and/or decisions made by an expert or administrator.

The network stage 110 may include any combination of neural networks and/or compatibility models configured to generate the pair of embeddings 132 and 134 associated with the product data 104 and 106, respectively. In some embodiments, the network stage 110 may include an ensemble compatibility model (ECM). The ECM may include a current iteration compatibility model and one or more preceding iteration compatibility models. Further, in some embodiments, the network stage 110 may determine new iterations of the compatibility model as will be further discussed below. In some embodiments, the network stage 110 may include attribute extractors 112 and 114 to assess the structured product attributes and the unstructured product attributes of the product data 104 and 106.

The comparison stage 130 compares the embeddings 132 and embeddings 134 to determine the extent to which the product data 104 of product A and the product data 106 of product B are compatible. In some embodiments, the comparison stage 130 may include labeling rules, the labeling rules being applied to the embeddings 132 and 134 to identify matching product attributes between the two products. In some embodiments, the comparison stage 130 may generate a compatibility label 136 from the embeddings 132 and 134 indicating a compatibility between the embeddings 132 and 134. In some embodiments, the compatibility label 136 may be a positive value or a negative value. In some embodiments, the compatibility label 136 may be a zero value indicating that the product pair in the data set is unmatchable.

For example, in one embodiment, given a product xₐ from category Xₐ, where xₐ∈Xₐ, the representation of xₐ includes structured product attributes wₐ=[w₁, w₂, . . . , wₙ], and unstructured product attributes τₐ. Consequently, in some embodiments, for a product category Xₐ, there is an attribute set Wₐ, such that ∀xₐ∈Xₐ, wₐ∈Wₐ. To compare two product corpus Xₐ and X_{b}, given a first product xₐ∈Xₐ and a second product x_{b}∈X_{b}, the compatibility between the first product xₐ and the second product x_{b} may be expressed by a compatibility label y, where y∈{1, −1}. Further, in some embodiments, given a product pair (xₐ, x_{b}), a labeling rule r(·) maps it into a label space: r(xa,xb)→y∈Y∪{0}, where Y is the compatibility label y∈{1, −1} and the union of {0}, indicating (xₐ, x_{b}) is unmatchable by the labeling rule r(·).

The output stage 140 may process information from the comparison stage 130, such as the compatibility label Y between the embeddings 132 and 134 corresponding to the compatibility of product data 104 of Product A and the product data 106 of product B. In some embodiments, the output stage 140 performs no additional operations, and simply transmits the compatibility label to other systems for subsequent processing and/or storage. Alternatively, in some embodiments, the output stage 140 may perform computations to assign a weighting to the compatibility label, determine a confidence level of the compatibility determination, determine a product recommendation ranking, other computations, and combinations thereof.

The output stage 140 may provide information to downstream processes associated with operation of the e-commerce platform. In some embodiments, an e-commerce platform may generate a product recommendation based on a user selection of a first product. In some embodiments, an e-commerce platform may generate a set of product recommendations relative to a particular product containing other products that are compatible to the particular product. In some embodiments, an example process may involve comparing the product data of the particular product with the product data for one or more products in a set of products purchased with a particular product. In some embodiments, the e-commerce platform may select a subset of potentially recommendable products and determine a ranking of recommended products based on an extent to which the two products match and/or display the subset of recommendable products in an order based on their ranking.

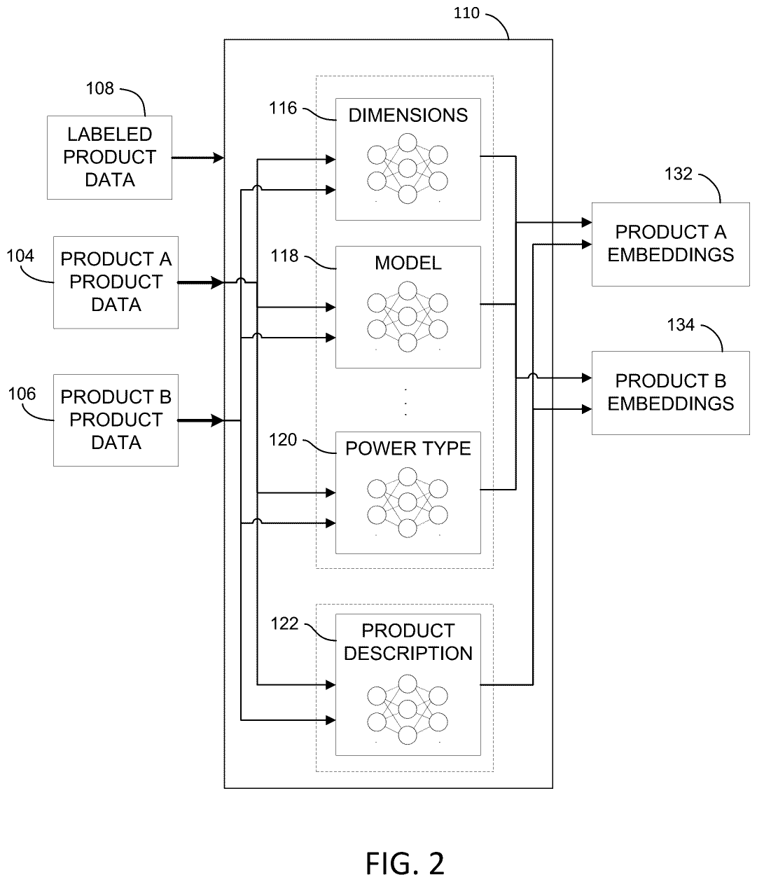

FIG. 2 is a block diagram of an example network stage 110, according to some embodiments. In some embodiments, the network stage 110 may include one or more neural networks and/or compatibility models. In some embodiments, the network stage 110 may include the ECM. The network stage 110 receives as inputs product data of products A and B, along with the data from the labeled product data 108. In some embodiments, product A may include an anchor product and product B may include another product from a same category as the anchor product. In some embodiments, the product A may include a product selected by a user and product B may be a candidate recommended product.

In some embodiments, the network stage 110 may include attribute extractors 112 and attribute extractors 114. Attribute extractors 112 and 114 may identify and extract the attributes from the product data of products A and B. In some embodiments, the network stage 110 may use the attribute extractor 112 and the attribute extractor 114 to generate the embeddings 132 and the embeddings 134. In some embodiments, the network stage 110 may use the attribute extractor 112 to generate the embeddings 132 and embeddings 134. In some embodiments, the network stage 110 may use the attribute extractor 114 to augment sparsely populated structured product attributes from the attribute extractor 112 to provide the embeddings 132 and the embeddings 134. In some embodiments, the attribute extractors 112 and 114 may include a machine learning engine, neural network, support vector machine (SVMs), kernel function, feature transformation, natural processing language engine, weak supervision learning framework (e.g., heuristics, knowledge bases, pre-trained models, etc.), and/or any other suitable processing structure to process the product corpus of product A and product B.

The attribute extractor 112 may identify compatible features from the high cardinality structured attributes contained in the product corpus. In some embodiments, the structured attributes may include product specification data for the products in the product pair. In some embodiments, the attribute extractor 112 may include a plurality of attribute extractors. The plurality of structured attributes may be associated with identifying different product specification categories of the products. For example, in some embodiments, the attribute extractor 112 may include a dimension extractor 116, a model extractor 118, a power type extractor 120, and other extractors for assessing the structured attributes of the products in the product pair. In some embodiments, the attribute extractor 112 may identify matching structured attributes from the product corpus between the products in the product pair and sends the matched structured attributes to the comparison stage 130 as embedding 132 and embedding 134 for product A and product B, respectively.

The attribute extractor 114 may identify compatible features from the low cardinality unstructured attributes contained in the product corpus. In some embodiments, the unstructured attributes may include a product description extractor 122. In some embodiments, the unstructured attributes may include, but are not limited to, product description, product overview, product guide, unlabeled text fields, other information, and combinations thereof, for products A and B. In some embodiments, the attribute extractor 114 may be used to supplement the attribute extractor 112 for any sparse product attributes that may be missing or incomplete from the structured product attributes. For example, the attribute extractor 114 may identify information from the product description including a manufacturer of a power tool and a manufacturer of a battery pack for the power tool based on missing structured attributes information identifying the manufacturer in the products. In some embodiments, the attribute extractor 114 may be used to construct a rule template based on the product data 104 of product A, the product data 106 of product B, and the sparse structured attributes of the product pair. In some embodiments, the rule template may be based on the product names of product A and product B, the product descriptions of product A and product B, and the sparse features from attribute extractor 112.

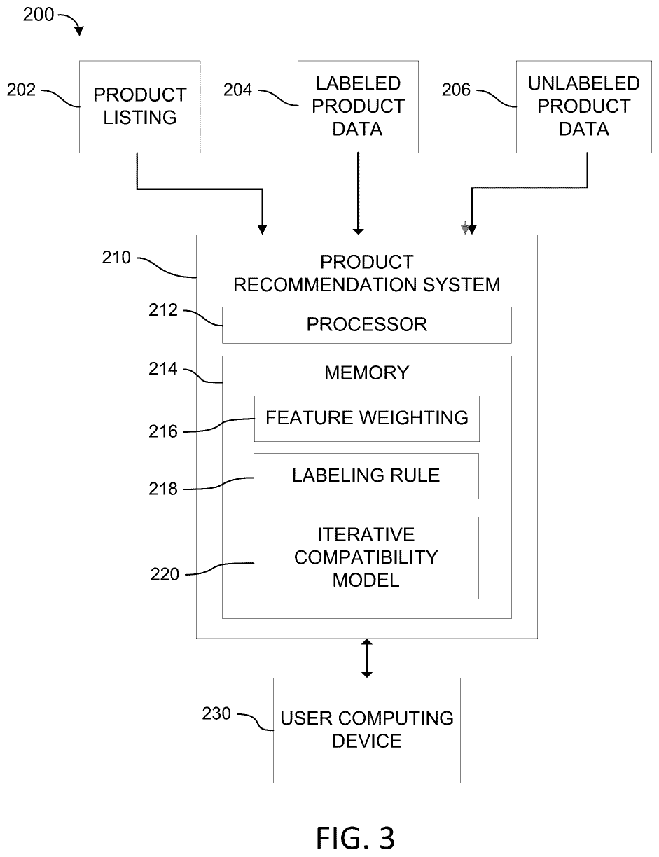

FIG. 3 is a block diagram of an example system 200 for recommending compatible products, according to some embodiments. The system 200 may include an electronic repository of a product listing 202, an electronic repository of labeled product data 204, an electronic repository of unlabeled product data 206, and a product recommendation system 210. The product recommendation system 210 may include a processor 212 and a non-transitory, memory 214 storing instructions that, when executed by the processor 212, cause the processor 212 to perform one or more steps, methods, algorithms, or other functionality of this disclosure. The instructions in the memory 214 may include one or more modules, such as a weighting module 216, labeling rule module 218, and an iterative compatibility model 220. The repository of the product listing 202, repository of labeled product data 204, repository of unlabeled product data 206 may each be embodied in one or more non-transitory computer-readable memories, such as one or more databases, for example.

The product listing 202 may include information respective of a particular product, such as a product offered by sale by a retailer. Such a product may be offered for sale through online sales and/or sales in brick-and-mortar stores. Information about the product may include a product category (e.g., by category and one or more sub-categories), a product name, product brand, product specification, textual product description, one or more product attributes or functions, one or more images or videos associated with the product, and/or other information. The product listing 202 may comprise, in some embodiments, a product information page that is displayable to a user on an e-commerce website when the user selects the product. Accordingly, the product listing 202 may include product information that is used as source data for populating an e-commerce website, in some embodiments. In some embodiments, the product listing 202 may include information associated with information in the labeled product data 204 and the unlabeled product data 206.

The labeled product data 204 may include labeled data for products. In some embodiments, the labeled product data 204 may include product data for products from the product listing 202. In some embodiments, the labeled product data 204 may include data representative of a subset of products from a retailer's entire catalog that share a common feature, category, or is otherwise related to the particular product in the product listing 202. In some embodiments, the labeled product data 204 may include data representative of the product corpus of the products in the labeled product data 204, the product listing 202, and other repositories. In some embodiments, the data representative of the products included in the labeled product data 204 may be based, at least in part, on user behavior data. The user behavior data may include user purchase data of products in the product listing 202, the labeled product data 204, and combinations thereof. In some embodiments, the user behavior data may include purchase data associated with a particular category and/or sub-category.

The unlabeled product data 206 may include unlabeled data for products of the product listing 202, the labeled product data 204, and combinations thereof. The unlabeled product data 206 may include data representative of unlabeled product pairs. In some embodiments, each of the unlabeled product pairs may be formed between an anchor object and randomly sampled other objects from the same category. In some embodiments, the data representative of the unlabeled product pairs may include user behavior data including purchase data associated with the anchor product and any co-purchased products. In some embodiments, the unlabeled product data 206 may include data representative of a particular product from the product listing 202 and other products that were co-purchased on the same transaction with the particular product by users of an e-commerce website, mobile application, brick-and-mortar point of sale system, or other interface with which the product recommendation system 210 is associated. In some embodiments, the unlabeled product data 206 may include co-purchase data for a fixed period of time, co-purchase data for products from a particular category and/or products from a sub-category or sub-categories related to the particular product. In some embodiments, the unlabeled product data 206 may include data representative of a user information for one or more users, a purchase frequency information, a confidence score associated with the product pair, and other information. For example, in some embodiments, the user information may include information associated with one or more users or learned based on the user's clickstream data and/or shopping history.

The product recommendation system 210 may be in electronic communication with one or more user computing devices 230. The product recommendation system 210 may receive the product listing 202 selected for viewing on the user computing device 230 and may generate one or more recommended products from the labeled product data 204 to display in association with the product listing 202 on a product listing page. In various examples, the product recommendation system 210 may select recommended products from the product listing 202 based on a user selection of a first product. The product recommendation system 210 may select products based on an application of the ECM to select recommended products that have attributes in common with the first product from the product listing 202 selected by the user. In some embodiments, the product recommendation system 210 may select one or more recommended products from the list of products associated with the product listing 202 and the labeled product data 204. The product recommendation system 210 may also sort, rank, or otherwise designate an order with which to display a set of selected product recommendations, based on their potential relevance to the user, based on the degree of visual similarity of the recommended products with respect to the product listing 202, based on a user behavior data, other factors, and combinations thereof.

The remainder of this disclosure will be described with reference to an embodiment where the product recommendation system 210 selects and/or ranks products to display with the product listing 202 based on their compatibility to the particular product, but such description is by way of example only. The product recommendation system 210 may be implemented as part of a product listing display module that dynamically generates the content to display on a product listing web page viewable on the user computing device 230.

The product recommendation system 210 may include the weighting module 216 described above with respect to FIG. 1, and/or may include one or more neural networks, classifiers, and/or compatibility models such as those described above with respect to FIGS. 1 and 2. The weighting module 216 may perform techniques described herein to generate a weighting for each product pair instance in the labeled data set of the labeled product data 204. In some embodiments, the weighting module 216 may apply an initial weight to each product pair instance for the labeled data from the labeled product data 204. In some embodiments, the product recommendation system 210 starts with an initial weight, wᵢ=1/|Dₗ|, for each labeled product pair in the labeled product data 204, where i=1, 2, . . . , |Dₗ|. During each iteration, the weighting module 216 may update the weighting of each product pair, where each wᵢ may be updated as the model's weight loss on instance xᵢ∈Dₗ, where Dₗ is the labeled dataset. To update the weighting during the iteration, the weighting module 216 computes an error rate, errₜ, based on the current compatibility model. For iteration t∈{1, . . . , T}, the weighted error rate, errₜ, on Dₗ is computed by: errₜ=Σᵢ₌₁^{|D}^{ₗ}^{|}wᵢ [symbol] (yᵢ≠mₜ(xᵢ))/Σᵢ₌₁^{|D}^{ₗ}^{|}wᵢ, to measure the performance of the compatibility model mₜ.

In some embodiments the weighting module 216 may calculate a model coefficient and associate the model coefficient to the current ECN. Consequently, in some embodiments, each iteration compatibility model may include a model coefficient. In some embodiments, the model coefficient may be based on the error rate of the labeled data set from labeled product data 204. In some embodiments, the model coefficient may be calculated by the weighting module 216, where

$$\\ {α}_{t} = log \frac{1 - {err}_{t}}{{err}_{t}} .$$

Further, in some embodiments, the weighting module 216 may update the weights for each labeled product pair in the labeled product data 204. The updated weights for each labeled product pair may be used by the product recommendation system 210 to identify error instances in the labeled data set as will be further discussed below. In some embodiments, the weighting module 216 may update the weights for each labeled product pair by: wᵢ←wᵢ· [symbol] , where i=1, 2, . . . , |Dₗ|.

The product recommendation system 210 may include the labeling rule module 218. The labeling rule module 218 may receive the product data for the product pair and apply the labeling rules to the embeddings 132 and 134 to map the product pair into a label space indicated by the compatibility label. In some embodiments, the labeling rule module 218 may identify the structured and unstructured product attributes from the product corpus of the product data.

The labeling rule module 218 may apply decision tree generation to assess the compatibility of the structured product attributes. In some embodiments, the structured product attributes may include categorical attributes, numerical attributes, other attributes, and combinations thereof. The categorical attributes may include qualitative values associated with a category and/or subcategory of the product specification. For example, a categorical attribute of a lighting fixture may indicate the types of lighting technologies that may be used with the lighting fixture. The numerical attributes may include quantitative values associated with the product specifications. For example, a numerical attribute may indicate a maximum wattage the lighting fixture may provide to a light bulb. In some embodiments, the labeling rule module 218 may capture the compatibility of product pairs by an exact matched categorical value, a within range numerical value, and/or a stand-alone attribute. To express such relation, the labeling rule module 218 may construct a concatenated input x from the anchor product xₐ and recommendation product x_{b}: x=[xₐ⊕x_{b}⊕(x′ₐ−x′_{b})], where x′ₐ, x′_{b} are the shared attributes of two products. In some embodiments, the shared attributes may include the same product attribute name. In some embodiments, the labeling rule module 218 may base the decision tree generation on the error instances identified by the updated weightings for each labeled product pair by: Dₜ={xⱼ}ⱼ₌₁ⁿ, s.t.{wⱼ}ⱼ₌₁ⁿ=Top−nwᵢ, where the i-th feature of the input x is denoted as fᵢ.

In some embodiments, the labeling rule module 218 may determine candidate labeling rules. In some embodiments, the labeling rule module 218 may select candidate labeling rules by calculating the permutation importance of each attribute. In some embodiments, the labeling rule module 218 may select the top-attributes according to the permutation importance to form the candidate labeling rules. For example, in some embodiments, the labeling rule module 218 may calculate the k-th score by the metric: ∅_{k,i}=∅(mₜm , D_{t,i}), where for each k in 1, . . . , K, K is the repeat times and D_{t,i}, indicates that the i-th column of the data set Dₜ is randomly shuffled. Further, the labeling rule module 218 may calculate the permutation importance of attribute fi by:

$$\\ {μ}_{i} = ∅ ( {m}_{t} , {D}_{t} ) - \frac{1}{K} {\sum }_{k = 1}^{K} {∅}_{k , i} .$$

In some embodiments, the candidate label rules, rⱼ, may be presented to a system expert or administrator for annotation prior to integration into rule set, Rₜ. In some embodiments, an annotation of a candidate rule may include an indication of an exact match, a range match, a contain match, and/or an abstain. In some embodiments, the exact match may indicate a particular attribute of the product pair be an exact match for the rule to be accepted. In some embodiments, the range match may indicate that for the set of attributes of the product pair (x′ₐ⊕x′_{b}), the attribute of one product falls within a range of the attribute of the other product. In some embodiments, the contain match may indicate that for the set of attributes in (x′ₐ⊕x′_{b}, the selected attribute of one product includes the original value instead of a filled placeholder. In some embodiments, the abstain may indicate a rejection of the candidate rule by the expert or system administrator.

In some embodiments, after rule annotation, the labeling rule module 218 may calculate a matching score for each product pair of the plurality of product pairs in the unlabeled data set, each product pair weighted by the feature importance determined by the weighting module 216. Consequently, in some embodiments, the structured attributes may be assessed for a hard match. If matched, the matching score will be accumulated with the corresponding feature importance: s_{t,j}^{d}=μj [symbol] (rⱼ==fⱼ^{u}), where fⱼ^{u} is the j-th feature of the unlabeled instance. Further, in some embodiments, for instances where the structured attributes are sparse, the unstructured attributes are checked for semantic similarity. Consequently, in some embodiments, the unstructured attributes, τ(xₜ^{u}), are fed into the label rule prompt of product pair instance, xₜ^{u}, to compute the matching score:

$$\\ {s}_{t , j}^{p} = μ j \frac{{e}_{t}^{u} - {e}_{j}^{r}}{‖ {e}_{t}^{u} ‖ \cdot ‖ {e}_{j}^{r} ‖} ,$$

where eₜ^{u} is the prompt embedding of xₜ^{u} and eⱼ^{r} is the rule embedding of rⱼ. In some embodiments, the matching scores of the structured attributes and the matching score of the unstructured attributes may be merged to determine a final matching score:

$$\\ {s}_{t , j} = {\sum }_{j}^{b} ( {s}_{t , j}^{d} + {s}_{t , j}^{p} ) = {\sum }_{j}^{b} μ j ( II ( {r}_{j} ⩵ {f}_{j}^{u} ) + \frac{{e}_{t}^{u} - {e}_{j}^{r}}{‖ {e}_{t}^{u} ‖ \cdot ‖ {e}_{j}^{r} ‖} .$$

The system 200 described above with respect to FIG. 3 may include one or more neural networks, classifiers, modules, and/or other models such as those described above with respect to FIGS. 1 and 2. In some embodiments, the iterative compatibility model 220 may generate a new iteration compatibility model based on the new labeling rules formed by the labeling rule module 218. In some embodiments, the new compatibility model may be based on an enlarged labeled dataset. In some embodiments, the enlarged labeled data set may be formed by applying the new labeling rules to the unlabeled data set to label the product pairs in the unlabeled data set. In some embodiments, the enlarged labeled data set may further include the labeled data set from labeled product data 204. In each iteration, t, the rule set Rₜ may be applied to the unlabeled dataset Dᵤ to generate an augmented dataset Dₗ∪Dₜ, the augmented dataset being used to train the compatibility model mₜ: (Xₐ, X_{b})→Y from the preceding models {mₜ}ₜ₌₁^{T} to obtain the final model f_{θ}(·): (Xₐ, X_{b})→Y, where interpretability of the model is provided by the generated rules {Rₜ}ₜ₌₁^{T}. In some embodiments, the iterative compatibility model 220 may combine the newly formed compatibility model with preceding iteration compatibility models to form the ECM. In some embodiments, the newly formed compatibility model may include a model coefficient from the weighting module 216 to optimize the newly formed compatibility model. From the enlarged data set, the model mₜ may be optimized by:

$$\\ {}_{\begin{matrix} \\ θ\end{matrix}}^{{}^{{}^{min}}} \frac{1}{\vert {D}_{t} \vert} {\sum }_{( {x}_{i} , {\hat{y}}_{i} ) ∈ {D}_{t}} {l}_{CE} ( {m}_{t} ( {x}_{i} ) , {\hat{y}}_{i} ) ,$$

where ŷᵢ is the weak label for instance xᵢ and l_{CE} is the cross entropy loss. In some embodiments, the optimized model mₜ may be augmented into the ensemble of the preceding compatibility models: f_{θ}(·)=Σₜⁿαₜmₜ, where the compatibility model mₜ with a low error rate errs may be assigned a higher coefficient αₜ.

The user computing device 230 may be, in some embodiments, a personal computer, mobile computing device, or the like. The user computing device 230 may be operated by a user of the website or other interface with which the product recommendation system is associated. The user computing device 230 may be configured to provide information to the product recommendation system 210, such as user behavior data, a user's location, and/or other information.

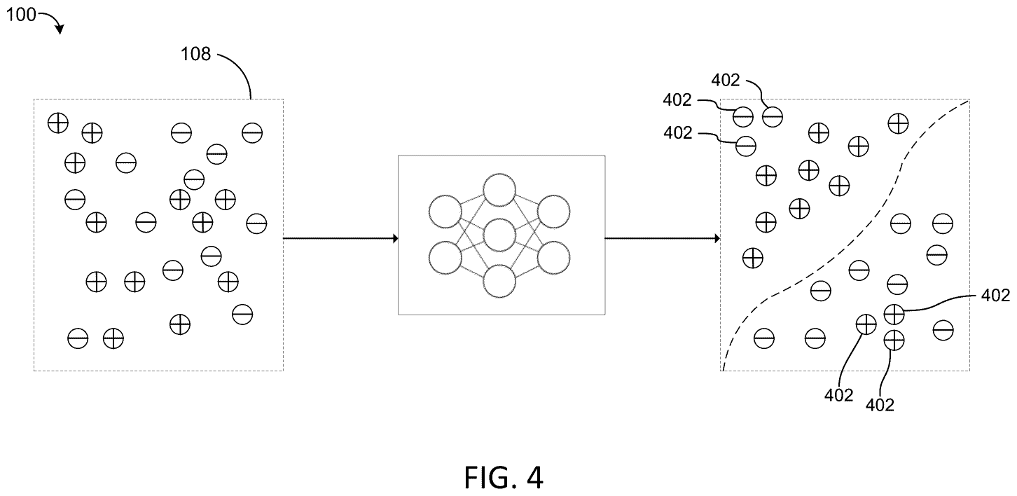

FIG. 4 is a block diagram of an example compatibility system 100, according to some embodiments. In some embodiments, the product recommendation system 210 may determine candidate labeling rules to augment the current rule set. In some embodiments, the product recommendation system 210 may apply the current iteration compatibility model to the labeled data set from labeled product data 204 to identify large error instances 402 of the object instances associated with the labeled product pairs in the labeled data set. In some embodiments, the labeled data set may be based on a previous iteration of the compatibility model. In some embodiments, the labeled data set may be based on a current iteration compatibility model. In some embodiments, the large error instances 402 may include false positive object instances and/or false negative object instances. In some embodiments, the large error instances 402 may be based on the weighting of the labeled product pairs of the labeled product data 204. In some embodiments, the large error instances 402 may be based on an updated weighting of the labeled product pairs in the labeled product data 204. In some embodiments, the product recommendation system 210 may target these error instances to provide candidate labeling rules to complement the current rule set R, and to suppress the noise in the initial weak data set and adaptively improve the ECM. In some embodiments, the labeling rule module 218 may determine candidate labeling rules by targeting error instances in the labeled data set from the labeled product data 204.

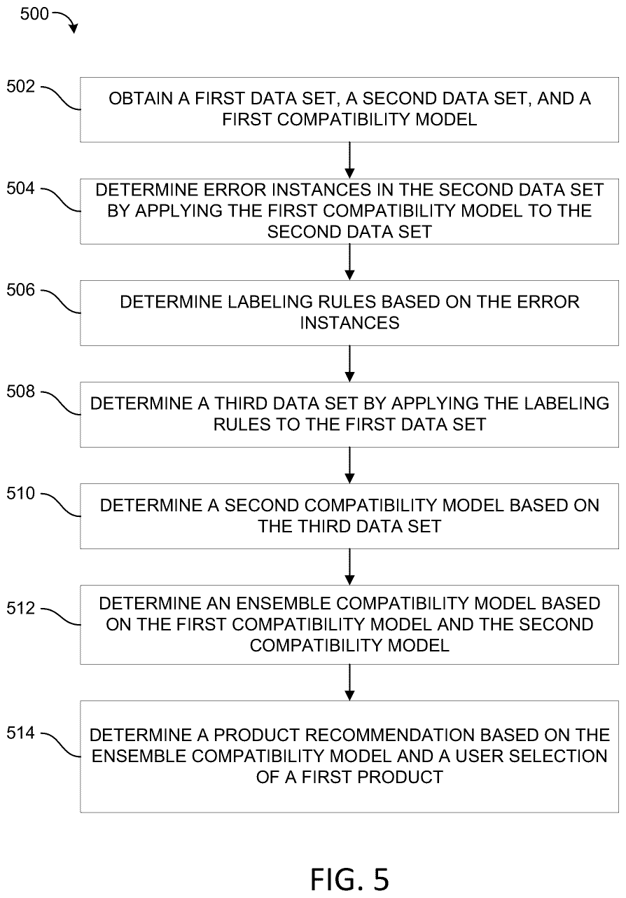

FIG. 5 is a flow chart of a method 500 for determining recommended products, according to some embodiments. The method 500 at 502 may include obtaining a first data set, a second data set, and a first compatibility model. In some embodiments, the first data set may include unlabeled product pairs. The unlabeled product pairs may be product pairs that have not been assessed by the compatibility system and not labeled with an object instance value. In some embodiments, the unlabeled product pairs may be product pairs that have not had the labeling rules applied to the product pairs. In some embodiments, the unlabeled product pair data may include randomly sampled product pairs, the randomly sampled product pairs including an anchor product and a randomly sampled other product from the same category and/or sub-category. In some embodiments, the first data set may be supplied from the product listing 202, the labeled product data 204, the unlabeled product data 206, and combinations thereof.

In some embodiments, the second data set may include labeled product pairs. In some embodiments, the labeled product pairs can be product pairs assessed by the preceding iteration of the compatibility model. In some embodiments, the labeled product pair may include a positive value, a negative value, or a zero value. The positive value indicating the products in the product pair are compatible. The negative vector value indicating the products are not compatible. The zero value indicating the compatibility of the products in the product pair cannot be determined by the compatibility model. In some embodiments, the second data set may be training data for the preceding compatibility model.

In some embodiments, the first compatibility model may be the preceding iteration compatibility model. In some embodiments, the first compatibility model may be an ensemble compatibility model including one or more compatibility models from preceding iterations. In some embodiments, the compatibility models may include a model weighting based on an error coefficient associated with the preceding iteration compatibility model. In some embodiments, the first compatibility model may include a first labeling rule. The first labeling rule may include one or more labeling rules developed by the compatibility model based on matching structured product attributes and the unstructured product attributes of the product pairs in the second data set. In some embodiments, the first labeling rule may include one or more rules from preceding iterations of the compatibility model. In some embodiments, the first labeling rule may include one or more labeling rules based on matching features from the structured product attributes and the unstructured product attributes associated with the product pairs in the second data set.

The method 500 at 504 may include determining error instances in the second data set by applying the first compatibility model to the second data set. In some embodiments, the error instance may be an indication of an incorrect object instance value for the product pair in the second data set. In some embodiments, the first compatibility model may identify large error instances in the second data set. In some embodiments, the large error instances may be one or more errors of a particular product pair combination. In some embodiments, the large error instances may be a number of errors for the particular product pair combination occurring beyond a predetermined occurrence threshold.

The method 500 at 506 may include determining labeling rules based on the error instances. In some embodiments, the labeling rules may be a second labeling rule. In some embodiments, the second labeling rule may include one or more rules. In some embodiments, the second labeling rule may be determined based on the structured product attributes and the unstructured product attributes between the product pairs from the error instances in the second data set. In some embodiments, the second labeling rule may be based on the large error instances in the second data set. In some embodiments, determining the second labeling rule may further include determining candidate labeling rules. In some embodiments, the candidate labeling rules may be provided to an expert or administrator to be assessed prior to an acceptance of the rule as a rule in the second labeling rules. In some embodiments, the assessment of the rule may include a categorization of the labeling rule as an exact match, a range, a contain, and/or an abstain.

The method 500 at 508 may include determining a third data set by applying the labeling rules to the first data set. The labeling rules are applied to the unlabeled product pairs in the first data set to map the compatibility of the product pair of the first data set. In some embodiments, the labeling rules may be the second labeling rules. In some embodiments, the labeling rules may be the first labeling rules and the second labeling rule. In some embodiments, the newly labeled data from the first data set may be augmented with the second data set to generate the third data set.

The method 500 at 510 may include determining a second compatibility model based on the third data set. In some embodiments, the second compatibility model may include the data from the third data set. In some embodiments, the second compatibility model may include the labeling rules. In some embodiments, the second compatibility model may include the second labeling rules. In some embodiments, the second compatibility model may include the first labeling rules and the second labeling rules.

The method 500 at 512 may include determining an ensemble compatibility model based on the first compatibility model and the second compatibility model. In some embodiments, the ensemble compatibility model may include the second compatibility model and one or more preceding iterations of the compatibility model. In some embodiments, the ensemble compatibility model may include a weighted ensemble of the preceding compatibility models. The preceding compatibility models may include the weight coefficient for that iteration compatibility model, the weight coefficient being based on the error rate for the respective iteration labeled data set.

The method 500 at 514 may include determining a product recommendation based on the ensemble compatibility model and a user selection of a first product. In some embodiments, the compatibility system may receive an indication from a user of a selection of the first product. In some embodiments, the compatibility system may also receive product data associated with the first product. In some embodiments the product data includes information on products from the same category or sub-category as the first product and may include the product specifications, product descriptions, product images, user behavior data associated with the products, other information, and combinations thereof. In some embodiments, the product data may include the third data set. The ensemble compatibility model of the compatibility system may provide a product recommendation based on the first product and the product data associated with the first product. In some embodiments, the ensemble compatibility system may provide one or more products recommendations may be based on the user selection of the first product. In some embodiments, the one or more product recommendations may be ranked based on the weightings of the product pairs.

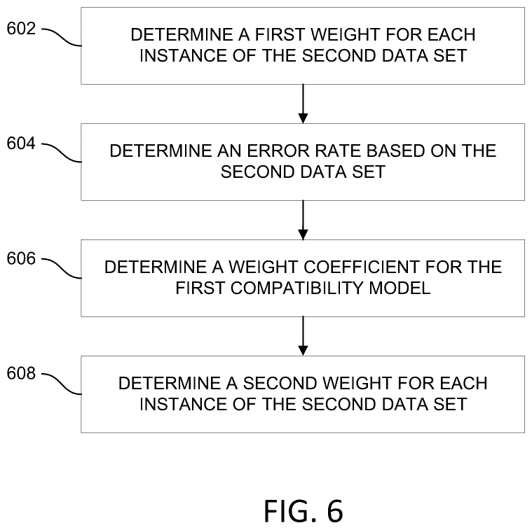

FIG. 6 is a flow chart of the method for determining recommended products, according to some embodiments. In some embodiments, the method 500 at 602 may include determining a first weight for each instance in the second data set. In some embodiments, the first weight may be an initial weight for each labeled product pair in the second data set.

In some embodiments, the method 500 at 604 may include determining an error rate based on the second data set. In some embodiments, the error rate may be based on the first compatibility model. In some embodiments, the error rate may be based on incorrect object instance associated with the labeled product pair in the second data set. In some embodiments, the error rate may be based on the first compatibility model yielding an incorrect determination of the compatibility of a product pair in the second data set. In some embodiments, the error rate may be based on the first compatibility model yielding an unmatchable compatibility label for a product pair in the second data set. In some embodiments, the error rate may be based on the number of incorrect object instances associated with labeled product pairs for the particular product pair in the second data set.

In some embodiments, the method 500 at 606 may include determining a weight coefficient for the first compatibility model. In some embodiments, the weight coefficient may be based on the error rate of the first compatibility model on the second data set. In some embodiments, the accuracy of the compatibility model may be based on the weight coefficient. For example, in some embodiments, a compatibility model having a low error rate may have a higher weight coefficient compared to another compatibility model having a higher error rate.

In some embodiments, the method 500 at 608 may include determining a second weight for each instance of the second data set. In some embodiments, the second weight may be based on the weight coefficient of the first compatibility model. In some embodiments, the second weight may include the first weight adjusted based on the weight coefficient of the first compatibility model as applied to each labeled product pair in the second data set. The compatibility system can use the second weights for each labeled product pair to iteratively develop more reliable rule-matched data and target weaknesses in the current compatibility model by proposing complementary candidate rules to augment the current rule set. For example, product pairs in the second data set having higher weights may be treated as large error instances, whereas newer labeled product pairs in the second data set with lower weights may not be treated as large error instances. Consequently, in some embodiments, large error instances may be associated with the weighting of each labeled product pair in the second data set.

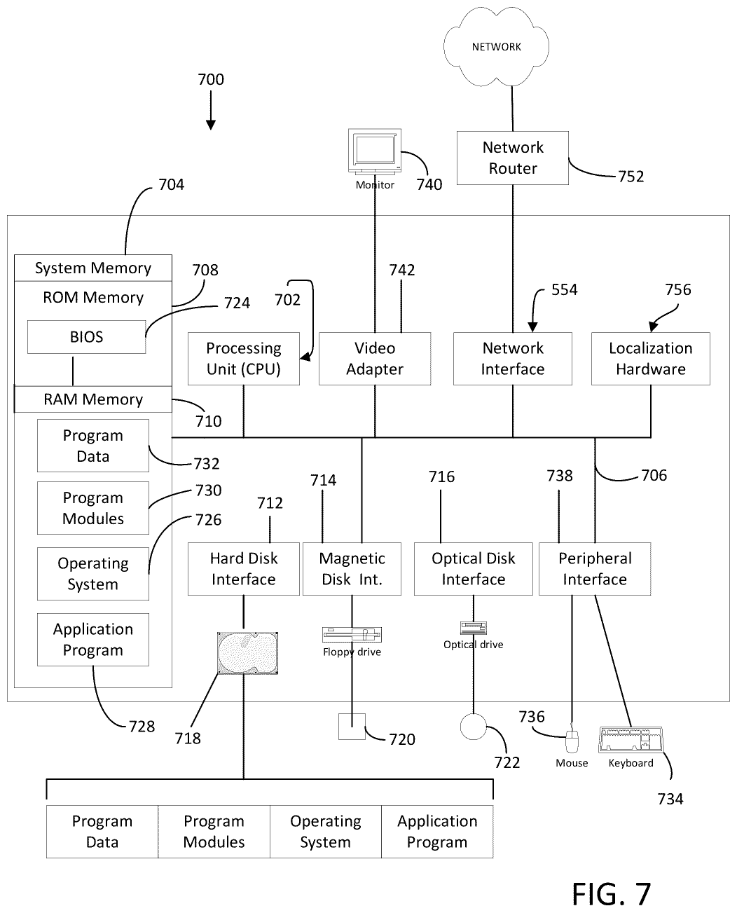

FIG. 7 is a diagrammatic view of an example computing system environment 700, according to some embodiments. In some embodiments, the computing system environment 700 may include a desktop computer, laptop, smartphone, table, or any other such device having the ability to execute instructions, such as those stored within a non-transient, computer-readable medium. Furthermore, while described and illustrated in the context of a single computing system 700, those skilled in the art will also appreciate that the various tasks described hereinafter may be practiced in a distributed environment having multiple computing systems 700 linked via a local or wide-area network in which the executable instructions may be associated with and/or executed by one or more of multiple computing systems 700.

Computing system environment 700 may include at least one processing unit 702 and at least one memory 704, which may be linked via a bus 706. Depending on the exact configuration and type of computing system environment, memory 704 may be volatile (such as RAM 710), non-volatile (such as ROM 708, flash memory, etc.) or some combination of the two. Computing system environment 700 may have additional features and/or functionality. For example, computing system environment 700 may also include additional storage (removable and/or non-removable) including, but not limited to, magnetic or optical disks, tape drives and/or flash drives. Such additional memory devices may be made accessible to the computing system environment 700 by means of, for example, a hard disk drive interface 712, a magnetic disk drive interface 714, and/or an optical disk drive interface 716. As will be understood, these devices, which would be linked to the system bus 706, respectively, allow for reading from and writing to a hard disk 718, reading from or writing to a removable magnetic disk 720, and/or for reading from or writing to a removable optical disk 722, such as a CD/DVD ROM or other optical media. The drive interfaces and their associated computer-readable media allow for the nonvolatile storage of computer readable instructions, data structures, program modules and other data for the computing system environment 700. Those skilled in the art will further appreciate that other types of computer readable media that may store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 700.

A number of program modules may be stored in one or more of the memory/media devices. For example, a basic input/output system (BIOS) 524, containing the basic routines that help to transfer information between elements within the computing system environment 700, such as during start-up, may be stored in ROM 708. Similarly, RAM 710, hard drive 718, and/or peripheral memory devices may be used to store computer executable instructions comprising an operating system 726, one or more applications programs 728 (such as one or more applications that execute the methods and processes of this disclosure), other program modules 730, and/or program data 732. Still further, computer- executable instructions may be downloaded to the computing environment 700 as needed, for example, via a network connection.

An end-user may enter commands and information into the computing system environment 700 through input devices such as a keyboard 734 and/or a pointing device 736. While not illustrated, other input devices may include a microphone, a joystick, a game pad, a smayner, etc. These and other input devices would typically be connected to the processing unit 702 by means of a peripheral interface 738 which, in turn, would be coupled to bus 706. Input devices may be directly or indirectly connected to processor 502 via interfaces such as, for example, a parallel port, game port, firewire, or a universal serial bus (USB). To view information from the computing system environment 700, a monitor 740 or other type of display device may also be connected to bus 706 via an interface, such as via video adapter 742. In addition to the monitor 740, the computing system environment 700 may also include other peripheral output devices, not shown, such as speakers and printers.

The computing system environment 700 may also utilize logical connections to one or more computing system environments. Communications between the computing system environment 700 and the remote computing system environment may be exchanged via a further processing device, such a network router 752, that is responsible for network routing. Communications with the network router 752 may be performed via a network interface component 754. Thus, within such a networked environment, e.g., the Internet, World Wide Web, LAN, or other like type of wired or wireless network, it will be appreciated that program modules depicted relative to the computing system environment 700, or portions thereof, may be stored in the memory storage device(s) of the computing system environment 700.

The computing system environment 700 may also include localization hardware 756 for determining a location of the computing system environment 700. In embodiments, the localization hardware 756 may include, for example only, a GPS antenna, an RFID chip or reader, a WiFi antenna, or other computing hardware that may be used to capture or transmit signals that may be used to determine the location of the computing system environment 700.

In embodiments, the computing system environment 700, or portions thereof, may comprise the repository of a product listing 202, the repository of labeled product data 204, the repository of unlabeled product data 206, the product recommendation system 210, and/or one or more user computing devices 230.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various embodiments of the present invention.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

What is claimed is:

1. A computer implemented method for determining object compatibility using a compatibility system, the method comprising:
obtaining a first data set, a second data set, and a first compatibility model;
determining, by the compatibility system, error instances in the second data set by applying the first compatibility model to the second data set;
determining, by the compatibility system, labeling rules based on the error instances;
determining, by the compatibility system, a third data set by applying the labeling rules to the first data set;
determining, by the compatibility system, a second compatibility model based on the third data set;
determining, by the compatibility system, an ensemble compatibility model based on the first compatibility model and the second compatibility model; and
determining, by the compatibility system, a product recommendation based on the ensemble compatibility model and a user selection of a first product.

2. The method of claim 1, wherein determining the error instances further comprises:
determining, by the compatibility system, a first weight for each instance of the second data set;
determining, by the compatibility system, an error rate based on the second data set;
determining, by the compatibility system, a weight coefficient for the first compatibility model; and
determining, by the compatibility system, a second weight for each instance of the second data set.

3. The method of claim 2, further comprising:
wherein the instances in the second data set with higher second weights are treated as large error instances, and
wherein the labeling rules are based on the large error instances in the second data set.

4. The method of claim 1, wherein the ensemble compatibility model further comprises a weighted ensemble of preceding compatibility models,
wherein each preceding compatibility model includes a weight coefficient.

5. The method of claim 1, further comprising:
wherein the first data set includes unlabeled product pair data, the unlabeled product pair data includes an anchor product from a product category and randomly sampled second products from the product category,
wherein the anchor product comprises the first product selectable by the user.

6. The method of claim 1, wherein the second data set includes labeled product pair data from a preceding iteration.

7. The method of claim 1, wherein the third data set comprises labeled product pair data based on the labeling rules being applied to the first data set.

8. The method of claim 7, wherein applying the labeling rules to the first data set comprises providing an object instance for each product pair indicating a compatibility of the product pair in the first data set.

9. The method of claim 1, wherein the labeling rules comprise being based on shared first attributes and second attributes between products in the product pair.

10. The method of claim 9, further comprising:
wherein the first attributes comprise structured attributes; and
wherein the second attribute comprise unstructured attributes.

11. A computer-implemented method for determining object compatibility using a neural network, the method comprising:
obtaining a first data set, a second data set, and a first compatibility model;
determining, by the neural network, error instances in the second data set by applying the first compatibility model to the second data set;
determining, by the neural network, labeling rules based on the error instances;
determining, by the neural network, a third data set by applying the labeling rules to the first data set;
determining, by the neural network, a second compatibility model based on the third data set;
determining, by the neural network, an ensemble compatibility model based on the first compatibility model and the second compatibility model; and
determining, by the neural network, a product recommendation based on the ensemble compatibility model and a user selection of a first product;
wherein the labeling rules comprise being based on shared attributes from first product attributes and second product attributes of the products in a product pair.

12. The method of claim 11, wherein determining the error instances further comprises:
determining, by the neural network, a first weight for each instance of the second data set;
determining, by the neural network, an error rate based on the second data set;
determining, by the neural network, a weight coefficient for the first compatibility model; and
determining, by the neural network, a second weight for each instance of the second data set.

13. The method of claim 12, further comprising:
wherein the instances in the second data set with higher second weights are treated as large error instances, and
wherein the labeling rules are based on the large error instances in the second data set.

14. The method of claim 11, wherein the ensemble compatibility model further comprises a weighted ensemble of preceding compatibility models,
wherein each preceding compatibility model includes a weight coefficient.

15. The method of claim 11, further comprising:
wherein the first data set includes unlabeled product pair data, the unlabeled product pair data includes an anchor product from a product category and randomly sampled second products from the product category,
wherein the anchor product comprises the first product selectable by the user.

16. The method of claim 11, wherein the second data set includes labeled product pair data from a preceding iteration.

17. The method of claim 11, wherein the third data set comprises labeled product pair data based on the labeling rules being applied to the first data set.

18. The method of claim 17, wherein applying the labeling rules to the first data set comprises providing an indication of the compatibility for each product pair in the first data set.

19. The method of claim 11, further comprising:
wherein the first product attributes comprise structured product attributes; and
wherein the second product attribute comprise unstructured product attributes.

20. A system for determining product compatibility using an ensemble compatibility model, the system comprising:
a processor; and
a non-transitory, computer-readable memory storing instructions that, when executed by the processor, cause the system to perform a method comprising:
obtaining a first data set, a second data set, and a first compatibility model;
determining, by a neural network, error instances in the second data set by applying the first compatibility model to the second data set;
determining, by the neural network, labeling rules based on the error instances;
determining, by the neural network, a third data set by applying the labeling rules to the first data set;
determining, by the neural network, a second compatibility model based on the third data set;
determining, by the neural network, an ensemble compatibility model based on the first compatibility model and the second compatibility model; and
determining, by the neural network, a product recommendation based on the ensemble compatibility model and a user selection of a first product;
wherein the labeling rules comprise being based on shared attributes from first product attributes and second product attributes of the products in a product pair.
